(19) United States
(12) Patent Application Publication
(10) Pub. No.: US 2015/0199219 A1
(43) Pub. Date: Jul. 16, 2015

(54) METHOD AND APPARATUS FOR SERVER CLUSTER MANAGEMENT

(71) Applicant: Samsung Electronics Co., Ltd., Gyeonggi-do (KR)

(72) Inventors: Ki-Soo KIM, Gyeonggi-do (KR); Hyun-Cheol KIM, Seoul (KR); Nam-Geol LEE, Seoul (KR); Sung-Jun YI, Gyeonggi-do (KR); Jae-Mok HONG, Seoul (KR)

(21) Appl. No.: 14/593,154

(22) Filed: Jan. 9, 2015

(30) Foreign Application Priority Data
Jan. 10, 2014 (KR) 10-2014-0003581

(51) Int. Cl. G06F 9/50; H04L 29/08

(52) U.S. Cl. CPC G06F 9/5011; H04L 67/10

(57) ABSTRACT

A method is provided comprising: receiving an incoming job request; estimating a first time necessary to complete the incoming job; adjusting a size of a server cluster based on the first time; and assigning the incoming job to a server that is part of the server cluster; wherein the size of the server cluster is adjusted before the incoming job is assigned to the server.

### CLAIM OF PRIORITY

The present application claims priority under 35 U.S.C. §119 to an application filed in the Korean Intellectual Property Office on Jan. 10, 2014 and assigned Serial No. 10-2014-0003581, the entire contents of which are incorporated herein by reference.

### BACKGROUND

1. Technical Field

The present disclosure relate to communications networks, and more particularly to a method and apparatus for server cluster management.

2. Description of the Related Art

An Infrastructure as a Service (IaaS)-based system (e.g., a digital content ecosystem) refers to a system that configures a server, a storage, and a network as a virtualization environment and can process digital contents while adjusting infra resources variably according to user's need.

### SUMMARY

The IaaS-based system can easily establish and dismantle a system by adjusting infra resources variably according to need. However, there is a problem that the IaaS-based system does not adjust infra resources used for processing digital contents until a problem arises in the infra resources. For example, the IaaS-based system adds a server for processing digital contents when a server for processing digital contents is overloaded or an abnormal operation of the server is detected.

According to aspects of the disclosure, a method is provided comprising: receiving an incoming job request; estimating a first time necessary to complete the incoming job; adjusting a size of a server cluster based on the first time; and assigning the incoming job to a server that is part of the server cluster; wherein the size of the server cluster is adjusted before the incoming job is assigned to the server.

According to aspects of the disclosure, an apparatus is provided comprising a memory and a processor configured to: receive an incoming job request; estimate a first time necessary to complete the incoming job; adjust a size of a server cluster based on the first time; and assign the incoming job to a server that is part of the server cluster; wherein the size of the server cluster is adjusted before the incoming job is assigned to the server.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram of an example of a system, according to aspects of the disclosure;

FIG. 2 is a diagram of an example of a management device, according to aspects of the disclosure;

FIG. 3 is a diagram of an example of a system, according to aspects of the disclosure;

FIG. 4 is a diagram of an example of a management device, according to aspects of the disclosure;

FIG. 5 is a flowchart of an example of a process, according to aspects of the disclosure;

FIG. 6 is a flowchart of an example of a sub-process, according to aspects of the disclosure;

FIG. 7 is a flowchart of an example of a sub-process, according to aspects of the disclosure; and

FIG. 8 is a flowchart of an example of a sub-process, according to aspects of the disclosure.

### DETAILED DESCRIPTION

Preferred embodiments of the present disclosure will be described herein below with reference to the accompanying drawings. In the following description, detailed descriptions of well-known functions or constructions will be omitted so that they will not obscure the disclosure in unnecessary detail. Also, the terms used herein are defined according to the functions of the present disclosure. Thus, the terms may vary depending on user's or operator's intentions or practices. Therefore, the terms used herein must be understood based on the descriptions made herein.

Hereinafter, the present disclosure describes a technology for managing infra resources for processing digital contents in an electronic device.

In the following description, the electronic device may manage infra resources for processing digital contents in a system which is configured to process digital contents by using resources of a virtual space like an IaaS-based system.

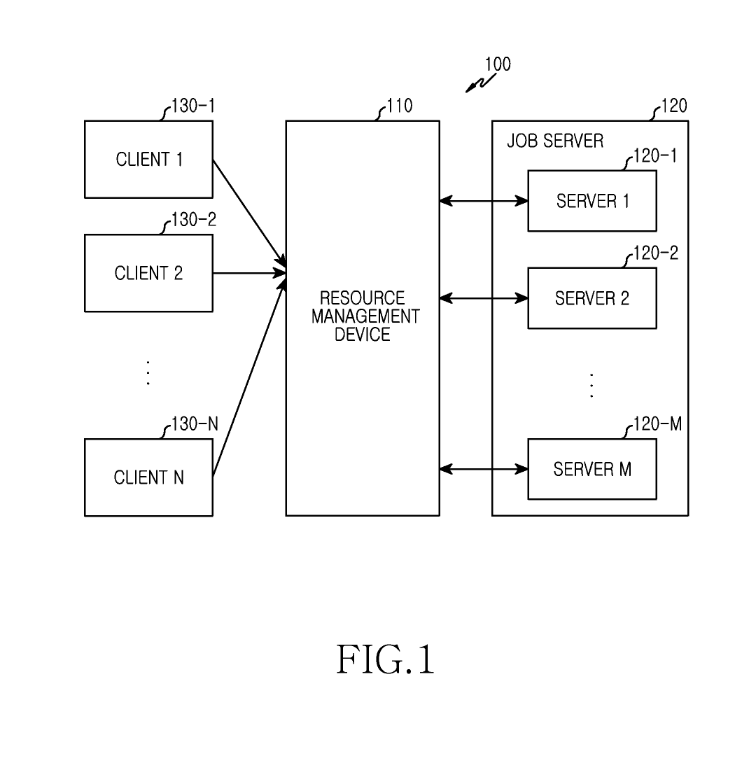

FIG. 1 is a diagram of an example of a system, according to aspects of the disclosure. In this example, the system includes client devices 130-1 through 130-N (where N can be any positive integer greater than one), a resource management device 110, and a server cluster 120. The server cluster 120 may include servers 120-1 through 120-M (where M can be any positive integer greater than one).

The resource management device 110 may include a processor, memory, and/or any other suitable type of hardware. In operation, the resource management device may automatically adjust the number of servers included in the server cluster 120 based on the load that is placed on the servers 120-1 through 120-N (auto scaling). For example, when it is detected that an event for determining a load occurs, the resource management device 110 may determine the load placed on each of the servers 120-1 to 120-M. Next, when a new job is provided from any of the clients 130-1 through 130-N, the resource management device 110 may estimate a time required to process the new job based on the load that is currently placed on the plurality of servers 120-1 through 120-M. Next, the resource management device 110 may adjust the number of servers included in the server cluster 120 accordingly. For example, the event for determining the load may occur periodically.

In some aspects, the resource management device 110 may distribute jobs to each of the servers 120-1 to 120-M based on the individual load that is placed on that server. For example, the resource management device 110 may distribute a new job provided from any of the clients 130-1 through 130-N to the server in the cluster 120 that is experiencing the lowest load.

In operation, each of the servers 120-1 to 120-M may process jobs distributed by the resource management device 110. For example, any given one of the servers 120-1 through 120-M may update a web service screen by executing code corresponding to the web service. As another example, any given one of the servers 120-1 through 120-M may perform Digital Rights Management (DRM) packaging of content.

Although the resource management device 110 is depicted as a monolithic block, in some implementations, the resource management device 110 may include a plurality of computing devices that are connected to each other via a communications network and/or any other suitable type of connection.

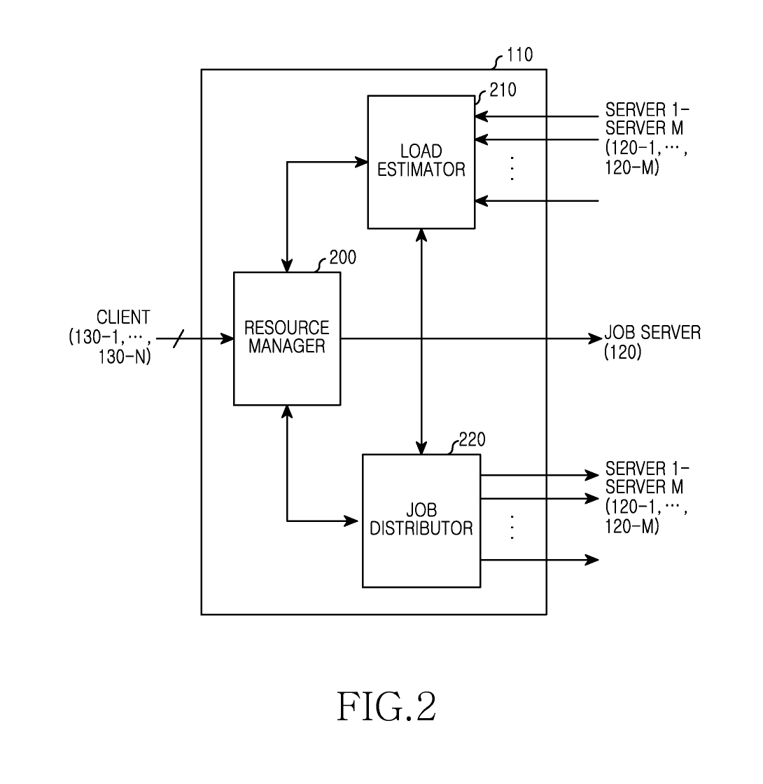

FIG. 2 is a block diagram of an example of one possible implementation of the management device 110. In this example, the management device 110 includes a resource manager 200, a load estimator 210, and a job distributor 220. Any of the resource manger 200, load estimator 210, and the job distributor 220 may be implemented using one or more processors. In some implementations, at least some of the resource manger 200, load estimator 210, and job distributor 220 may be implemented as separate physical devices (e.g. computers) that are connected to one another over a communications network. Additionally or alternatively, in some implementations, at least some of the resource manger 200, load estimator 210, and job distributor 220 may be integrated together in the same physical device.

In operation, the resource manager 200 may receive an indication of an estimated time required to complete a new job from the load estimator 210. Next, the resource manager 200 may adjust the number of servers in the server cluster 120 based on the estimated time required to complete the job. Here, the estimated time required to complete the new job indicates the processing time of the new job, once execution of the new job has began.

For example, when a new job is provided from one or more clients 130-1 to 130-N, the resource manager 200 may request from the load estimator 210 an estimated time required to process the new job. The resource manager 200 may then adjust the number of servers included in the server cluster 120 based on the estimated time required to process the new job (which is provided by the load estimator 210).

In some aspects, the load estimator 210 may estimate the processing time of the new job in response to the request for the estimated time. Next, the load estimator 210 may determine the load that is individually placed on each one of the servers 120-1 through 120-M. Afterwards, the load estimator 210 may estimate the time required to finish the new job based on the load on each of the servers 120-1 to 120-M and the processing time of the new job. And finally, the load estimator 210 may provide an indication of the estimated time to the resource manager 300.

In some implementations, the load estimator 210 may periodically collect load information on each of the servers 120-1 to 120-M. For example, when a predetermined event is generated, the load estimator 210 may request load information from each of the servers 120-1 to 120-M and may collect the load information on each of the servers 120-1 to 120-M. In some implementations, the event may be generated periodically by the load estimator 210.

The job distributor 220 may distribute jobs to each of the servers 120-1 to 120-M based on their respective loads. Specifically, the job distributor 220 may determine a job processing priority for each of the servers 120-1 through 120-M based on that server's current load. For example, when much time is left for a server to process a current job, the job distributor 220 may give a high job processing priority to the corresponding server. When a list of jobs is provided from the resource manager 200, the job distributor 220 may distribute the jobs in the list of jobs to each of the servers 120-1 to 120-M based on their respective job processing priorities. For example, servers with high job processing priorities may be allocated jobs first.

According to various aspects of the present disclosure, the resource manager 200 may estimate the time required to process the new job and the load on each of the servers 120-1 through 120-M, which is provided from the load estimator 210. The resource manager 200 may adjust the number of servers included in the server cluster 120 based on the estimated job processing time.

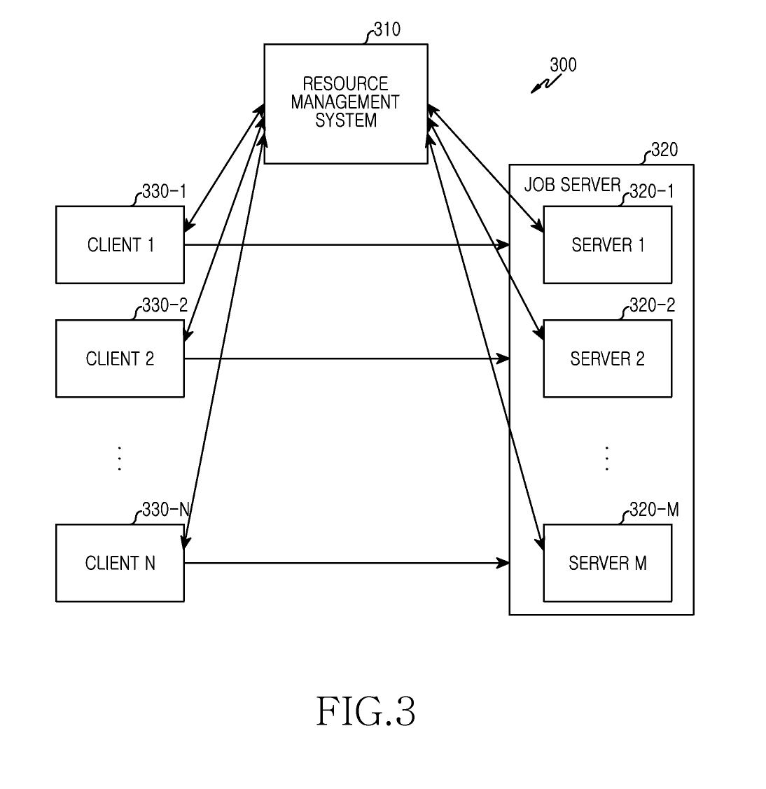

FIG. 3 is a diagram of an example of a system, according to aspects of the disclosure. In this example, the system includes client devices 330-1 through 330-N (where N can be any positive integer greater than one), a resource management device 310, and a server cluster 320. The server cluster 320 includes servers 320-1 through 320-M (where M can be any positive integer greater than one).

The resource management device 310 may include a processor, memory, and/or any other suitable type of hardware. In operation, the resource management device 310 may automatically adjust the number of severs included in the server cluster 320 based on the load that is placed on the servers 320-1 through 320-N. For example, when it is detected that an event for determining a load occurs, the resource management device 310 may determine the load of each of the servers 320-1 to 320-M. Next, when an upload request is received from one or more clients 330-1 to 330-N, the resource management device 310 may estimate the number of sessions or threads necessary for uploading a content item based on the loads of the plurality of servers 320-1 to 320-M, and may adjust the number of servers included in the server cluster 320. In some implementations, the upload request may include a request to upload data from the client to the server cluster. The request may necessitate the allocation of resources (e.g., network resources) by one or more servers that are part of the cluster.

The resource management device 310 may select at least one of servers 320-1 through 320-M to service the upload request. The selection may be made on the respective loads of at least some of the servers 320-1 through 320M. For example, the resource management device 310 may determine one or more servers that have a small amount of content left to be uploaded before completing a previous upload request. When one or more of the servers 320-1 through 320-M are selected to service the new upload request, the resource management device 310 may transmit an identifier of each (or at least one) of the selected servers to the client device from which the upload request originated.

Each of the servers 320-1 to 320-M may process the job distributed by the resource management device 310. For example, the server 320-1, . . . or 320-M may set a communication link with one or more clients 330-1, . . . or 330-N based on determination of the resource management device 310 and may process a content uploaded by one or more clients 330-1 to 330-N.

Although the resource management device 310 is depicted as a monolithic block, in some implementations, the resource management device 310 may include a plurality of computing devices that are connected to each other via a communications network and/or any other suitable type of connection.

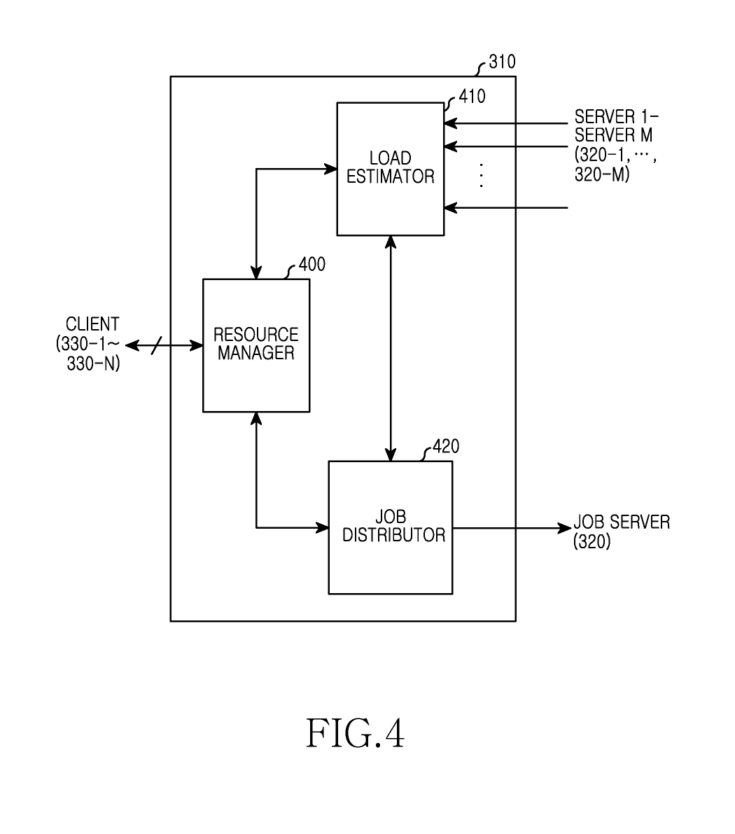

FIG. 4 is a block diagram of an example of one possible implementation of the management device 310. In this example, the management device 310 includes a resource manager 400, a load estimator 410, a job distributor 420. Any of the resource manger 400, load estimator 410, and the job distributor 420 may be implemented using one or more processors. In some implementations, at least some of the resource manger 400, load estimator 410, and job distributor 420 may be implemented as separate physical devices (e.g. computers) that are connected over a communications network (e.g., a TCP/IP network). Additionally or alternatively, in some implementations, at least some of the resource manger 400, load estimator 410, and job distributor 420 may be integrated together in the same physical device.

The resource manager 400 may adjust the number of servers included in the server cluster 320. For example, when an upload request is received from one or more clients 330-1 through 330-N, the resource manager 400 may request load information on each of the servers 320-1 through 320-M from the load estimator 410. The resource manager 400 may estimate the number of sessions or threads necessary for uploading the content based on load information on each of the servers 320-1 through 320-M, which is provided from the load estimator 410, and may adjust the number of servers included in the server cluster 320 accordingly.

The load estimator 410 may determine a load on each of the servers 320-1 through 320-M. The load estimator 410 may transmit the load information on each of the servers 320-1 to 320-M to the resource manager 400 or the job distributor 420 in response to the request of the resource manager 400 or the job distributor 420.

The job distributor 420 may select at least one of the servers 320-1 through 320-M to service the upload request based on the respective loads of the servers 320-1 to 320-M. For example, the job distributor 420 may select a server that has a small amount of content left to be uploaded before completion of the upload request that is currently being serviced by the server. Afterwards, the resource manager 400 may transmit an identifier of the selected server to the client device from which the upload request originated.

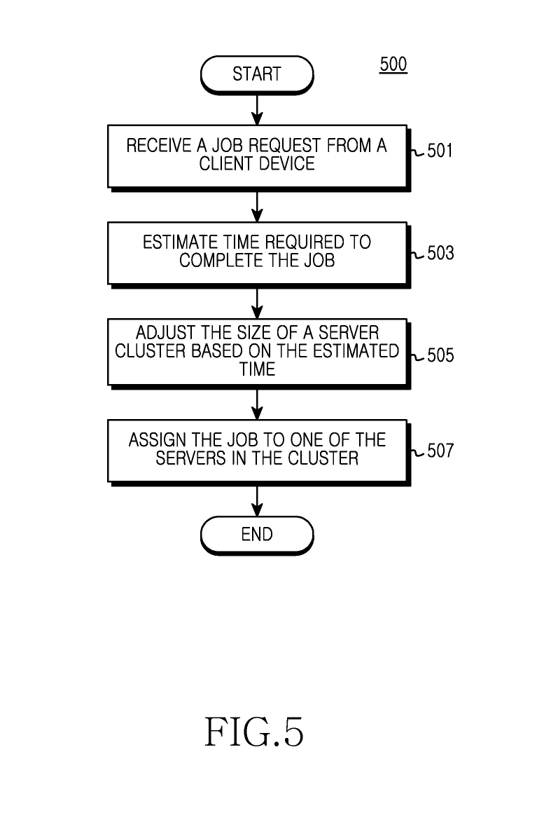

FIG. 5 is a flowchart of an example of a process, according to aspects of the disclosure.

In step 501, a resource management device (e.g. resource management device (110 or 310) may receive a job request from a client device.

In step 503, the resource management device may estimate a time needed to complete the new job. The estimation may be made based on the respective loads of one or more servers in a server cluster.

In step 505, the resource management device may adjust a size of the server cluster based on the estimated time. For example, the resource management device may estimate the number of servers necessary for processing the new job based on the estimated time required to process the new job. The resource management device may then adjust the number of servers included in the server cluster accordingly.

For example, the resource management device may estimate the number of sessions or threads necessary for uploading a content based on the estimated time required to process the new job. The resource management device may then use the number of sessions or threads necessary for uploading the content as a basis for adjusting the number of servers included in the server cluster on the basis of.

In step 507, the resource management device assigns the new job to one of the servers in the cluster.

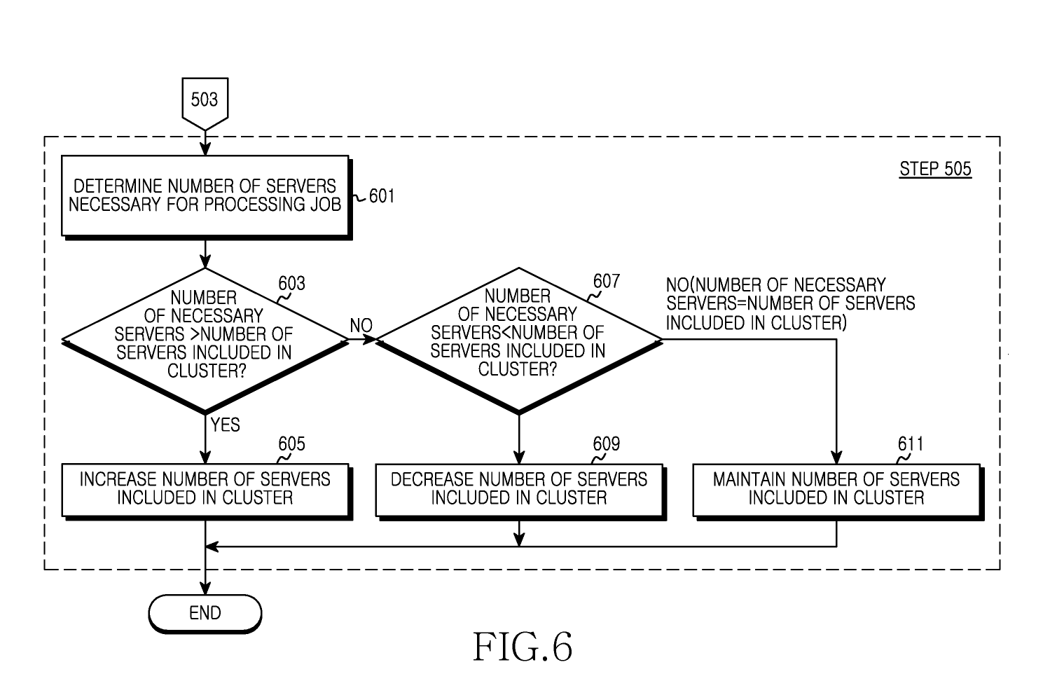

FIG. 6 is a flowchart of an example of a process for performing step 505 of process 500, according to aspects of the disclosure. In step 601, when the time required to process the new job is estimated in step 503 of FIG. 5, the resource management device determines a number of required servers. In some implementations, the number of required servers may indicate the total number of servers necessary to complete, within a predetermined time period, the new job and all other jobs that are pending with the cluster before the new job. Additionally or alternatively, the number of required servers may indicate the total number of servers necessary to complete, within a predetermined time period, the new job and at least one other job that is pending with the server cluster before the new job. For example, the resource management device may determine the number of servers necessary for processing the job based on an amount of content that should be processed in the server cluster in response to the new job and an amount of content that needs to be processed in the server cluster before the new job can begin being processed.

In some implementations, the resource management device may determine the number of servers necessary for processing the job based on the estimated job processing time and a time left for the server cluster to process all other jobs that are currently pending before the cluster, as shown in Equations 1 and 2:

$$\begin{matrix}N = ( K + A ) / T & ( Eq . 1 ) \\ A = \frac{{\sum }_{p = 1}^{P = M} {t}_{p}}{M} & ( Eq . 2 )\end{matrix}$$

wherein, N is number of servers necessary for DRM packaging;
K is an estimate of the time it would take the cluster to complete the new job (DRM packaging), once execution of the new job has begun;
A is an estimate of the time it would take the cluster to complete all jobs (DRM packaging) that are queued in the cluster before the new job;
T is a time period within which the new job must be completed to ensure a desired quality-of-service;
M is the current number of servers in the cluster; and
tₚ is time left for the p-th server to complete all jobs that have been assigned to the p-th server.

In step 603, the resource management device may determine whether the number of servers necessary exceeds the number of servers included in the server cluster in step 603.

In step 605, when the number of servers necessary to be present in the cluster exceeds the number of servers included in the server cluster, the resource management device may increase the number of servers included in the server cluster.

In step 607, when the number of servers necessary to be present in the cluster does not exceed the number of servers included in the server cluster, the resource management device may determine whether the number of servers necessary to be present in the cluster is smaller than the number of servers included in the server cluster.

In step 609, when the number of servers necessary to be present in the cluster is smaller than the number of servers included in the server cluster, the resource management device may decrease the number of servers included in the server cluster.

In step 611, when the number of servers necessary to be present in the cluster is equal to the number of servers included in the server cluster, the resource management device may maintain the number of servers included in the server cluster.

In the case of FIG. 6, the resource management device may estimate the number of servers necessary for processing the job and adjust the number of servers included in the server cluster.

Additionally or alternatively, in some implementations, the resource management device may estimate the number of sessions or threads necessary for processing content stably in response to a new job in the server cluster. For example, when the number of sessions necessary for processing the new job and at least some (or all) other jobs that are queued in the cluster before the new job is assigned to a server is smaller than the total number of sessions that the server cluster can support or when the number of threads necessary for processing the job is smaller than the total number of threads the server cluster can support, the resource management device may decrease the number of servers included in the server cluster.

In addition, when a ratio of the number of sessions necessary for processing the new job to the total number of sessions included in the server cluster and a ratio of the number of threads necessary for processing the new job to the total number of threads that the server cluster can support is less than or equal to 50%, the resource management device may decrease the number of servers included in the server cluster.

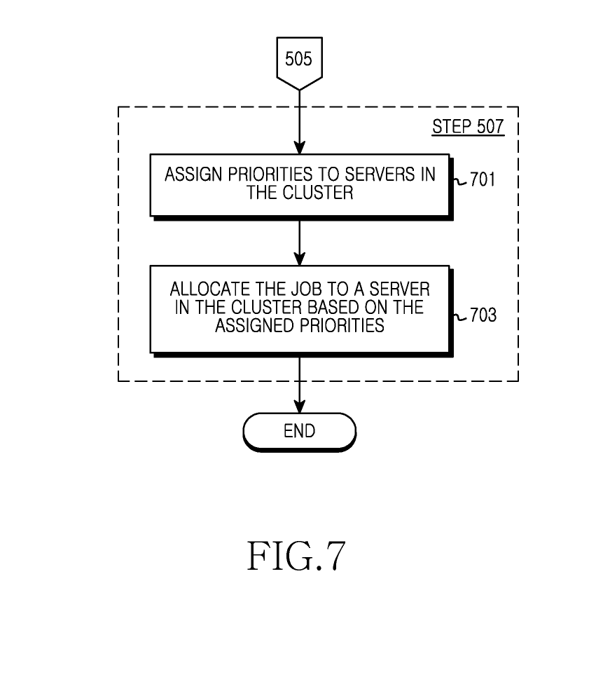

FIG. 7 is a flowchart of an example of a process for performing step 507 of process 500, according to aspects of the disclosure. In step 701, when the size of the server cluster is adjusted in step 505 of FIG. 5, the resource management device may determine a priority for each (or at least some) server(s) in the cluster based on the load that is currently placed on that server. For example, when time t₁ is left for a server in the cluster to process a current job, the resource management device may give assign a job processing priority p₁ to the server. By contrast, when a time t₂ is left for another server in the cluster to complete the job the other server is currently processing, the resource management device may assign a job processing priority p₂ to the other server, wherein t₁>t₂ and p₁<p₂ In this example, the higher the value of p, the higher the priority.

In step 703, the resource management device may allocate the new job to a server in the cluster based on the respective priorities of a plurality of servers in the cluster. For example, the resource management device may allocate the new job to the server that has the highest priority.

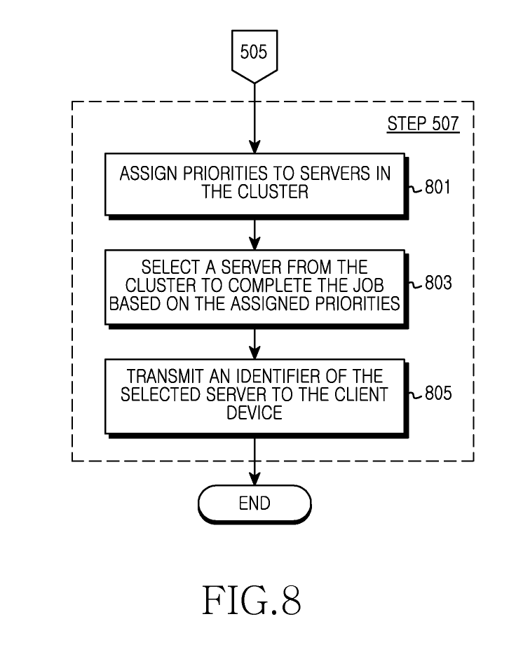

FIG. 8 is a flowchart of an example of a process for performing step 507 of process 500, according to aspects of the disclosure.

In step 801, referring to FIG. 8, when the size of the server cluster is adjusted in step 505 of FIG. 5, the resource management device may assign a priority to each (or at least some) server in the cluster based on the load of each server included in the server cluster. For example, when a server in a cluster is currently uploading a first file having a size s₁ to a client device, the resource management device may assign a priority p₁ to that server. By contrast, when another server in a cluster is currently uploading a second file having size s₂ to a client device, the resource management device may assign a priority p₂ to that server, wherein s₁>s₂ and p₁<p₂. In other words, in some implementations the priority assigned to each server may be inversely proportional to the size of the file that is being uploaded to that server by a respective client device

In step 803, the resource management device may select a server for uploading a content requested by one or more clients based on the respective priorities assigned at step 801. For example, the resource management device may select the server having the highest of all assigned priorities.

In step 805, the resource management device may transmit an identifier for the selected server to a client device that requested the content upload.

In the foregoing examples, the resource management device may transmit to the client information on one or more servers for uploading content requested by a client. In this case, the client which requested content uploading may access a corresponding server based on the server information provided from the resource management device and may upload the content.

As described, the system which provides resources of a virtual space can adjust the size of infra resources by estimating a load of infra resources (auto scaling), and can distribute a job to infra resources based on the load of infra resources, so that the system can improve a processing speed of digital contents and can efficiently manage the infra resources.

FIGS. 1-8 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the present disclosure. Under the broadest reasonable interpretation, the appended claims constitute statutory subject matter in compliance with 35 U.S.C. §101.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method comprising:
receiving an incoming job request;
estimating a first time necessary to complete the incoming job;
adjusting a size of a server cluster based on the first time; and
assigning the incoming job to a server that is part of the server cluster;
wherein the size of the server cluster is adjusted before the incoming job is assigned to the server.

2. The method of claim 1, wherein the size of the server cluster includes the number of server included the server cluster.

3. The method of claim 1, wherein the incoming job includes executing a web service by the server.

4. The method of claim 1, wherein the incoming job includes receiving content by the server, the content being transmitted from a client device.

5. The method of claim 1, further comprising estimating a second time necessary for the server cluster to complete at least some jobs queued in the server cluster before the incoming job,
wherein the adjusting the size of the server cluster comprises:
adjusting the size of the server cluster based on the first time and the second time.

6. The method of claim 5, wherein the adjusting the size of the server cluster comprises:
determining the number of servers necessary to be present in the server cluster in order for the incoming job and at least some jobs to be completed based on the first time and the second time;
adjusting the size of the server cluster based on the determined the number of servers.

7. The method of claim 5, wherein the adjusting the size of the server cluster comprises:
determining the number of servers necessary to be present in the server cluster in order for the incoming job and at least some jobs to be completed by comparing an amount of content that should be processed in the one or more servers included in the server cluster and an amount of content that can be processed in the one or more servers until the first time and the second time;
adjusting the size of the server cluster based on the determined the number of servers.

8. The method of claim 1, wherein the assigning the incoming job to a server that is part of the server cluster comprises:
assigning the incoming job to a server that is part of the server cluster based on the load on each of the servers included the server cluster.

9. The method of claim 1, further comprising:
transmitting information on the one or more servers to process the incoming job to one or more clients which requested the incoming job.

10. An apparatus comprising a memory and a processor configured to:
receive an incoming job request;
estimate a first time necessary to complete the incoming job;
adjust a size of a server cluster based on the first time; and
assign the incoming job to a server that is part of the server cluster;
wherein the size of the server cluster is adjusted before the incoming job is assigned to the server.

11. The apparatus of claim 10, wherein the size of the server cluster includes the number of server included the server cluster.

12. The apparatus of claim 10, wherein the incoming job includes executing a web service by the server.

13. The apparatus of claim 10, wherein the incoming job includes receiving content by the server, the content being transmitted from a client device.

14. The apparatus of claim 10, wherein the processor is configured to estimate a second time necessary for the server cluster to complete at least some jobs queued in the server cluster before the incoming job, wherein the size of the server cluster is adjusted based on the first time and the second time.

15. The apparatus of claim 14, wherein the processor is configured to determine the number of servers necessary to be present in the server cluster in order for the incoming job and at least some jobs to be completed based on the first time and the second time, wherein the size of the server cluster is adjusted based on the determined the number of servers.

16. The apparatus of claim 14, wherein the processor is configured to determine the number of servers necessary to be present in the server cluster in order for the incoming job and at least some jobs to be completed by comparing an amount of content that should be processed in the one or more servers included in the server cluster and an amount of content that can be processed in the one or more servers until the first time and the second time, wherein the size of the server cluster is adjusted based on the determined the number of servers.

17. The apparatus of claim 10, wherein the processor is configured to assign the incoming job to a server that is part of the server cluster based on the load on each of the servers included the server cluster.

18. The apparatus of claim 10, wherein the processor is further configured to transmit information on the one or more servers to process the incoming job to one or more clients which requested the incoming job.
